(19) United States
(12) Patent Application Publication
(10) Pub. No.: US 2024/0256865 A1
(43) Pub. Date: Aug. 1, 2024

(54) TRAINING NEURAL NETWORKS USING LEARNED OPTIMIZERS

(71) Applicant: Google LLC, Mountain View, CA (US)

(72) Inventors: Deepali Jain, Bangalore (IN); Krzysztof Marcin Choromanski, Lincroft, NJ (US); Sumeet Singh, New York, NY (US); Vikas Sindhwani, Hastings-on-Hudson, NY (US); Tingnan Zhang, Sunnyvale, CA (US); Jie Tan, Mountain View, CA (US); Kumar Avinava Dubey, Palo Alto, CA (US)

(21) Appl. No.: 18/430,586

(22) Filed: Feb. 1, 2024

(30) Foreign Application Priority Data
Feb. 1, 2023 (IN) 202321006562

(51) Int. Cl. G06N 3/08; G06N 3/0455

(52) U.S. Cl. CPC G06N 3/08; G06N 3/0455

(57) ABSTRACT

Methods, systems, and apparatus, including computer programs encoded on computer storage media, for training neural networks. One of the methods for training a neural network configured to perform a machine learning task includes performing, at each of a plurality of iterations: performing a training step to obtain respective new gradients of a loss function; for each network parameter: generating an optimizer network input; processing the optimizer network input using an optimizer neural network, wherein the processing comprises, for each cell: generating a cell input for the cell; and processing the cell input for the cell to generate a cell output, wherein the processing comprises: obtaining latent embeddings from the cell input; generating the cell output from the hidden state; and determining an update to the hidden state; and generating an optimizer network output defining an update for the network parameter; and applying the update to the network parameter.

### CROSS-REFERENCE TO RELATED APPLICATION

This application is based upon and claims the benefit of priority to the prior Indian Provisional Application No. 202321006562, filed on Feb. 1, 2023. The disclosure of the prior application is considered part of and is incorporated by reference in the disclosure of this application.

### BACKGROUND

This specification relates to training neural networks. Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification describes a system implemented as computer programs on one or more computers in one or more locations that uses a neural network that uses an approximation of an attention mechanism to perform a task.

For example, the task for the neural network can be to serve as an optimizer neural network. The optimizer neural network can be configured to train a second neural network (called a “trainee” neural network within) that is configured to perform a particular machine learning task. The optimizer neural network can generate network outputs that specify updates to parameters of the trainee neural network.

The subject matter described in this specification can be implemented in particular embodiments so as to realize one or more of the following advantages.

Generally, using techniques described in this specification, a system can execute an optimizer neural network that determines updates to parameter values of a trainee neural network during the training of the trainee neural network. By using the described optimizer neural network to determine the updates, i.e., instead of an optimization rule or a different optimizer neural network, the training of the trainee neural network can be improved, resulting in the trainee neural network being trained to have improved performance on the machine learning task, the training consuming fewer computational resources, or both. For example, the optimizer neural network can include one or more cells that each maintain one or more hidden states with an approximated attention mechanism, which requires fewer computational resources.

In some implementations described herein, the system can be implemented on parallel processing hardware, e.g., special-purpose hardware such as tensor processing units (TPUs), for efficient execution at training and/or inference time, as described in more detail below. The special-purpose hardware can be optimized for performing the attention operations of a transformer. For example, if the trainee neural network is a transformer, the optimizer neural network can be implemented on the same special-purpose hardware. Thus, training the traince neural network can be done more efficiently than if the optimizer neural network were a neural network of a conventional system, such as a recurrent neural network (RNN).

The system can avoid the catastrophic forgetting that is common in conventional systems, such as those where the optimizer neural network is an RNN, by using a transformer architecture with an approximated attention mechanism for the optimizer neural network. For example, the optimizer neural network can include one or more cells that each maintain one or more hidden states with an approximated attention mechanism. Each hidden state includes a key-value hidden state element and a key hidden state element, derived from a feature mapping to approximate kernel values.

Moreover, the system can also reduce the space and time complexity compared to a system where the optimizer neural network has a conventional transformer architecture with a conventional attention mechanism. For example, the system can use a transformer that approximates attention via low-rank decomposition of the attention matrix. For example, the transformer described in this specification can provide compactification through a fixed-size hidden state, as well as expressiveness through the hidden state that approximates a conventional transformer's attention.

The system can generalize better than conventional learning optimizers. For example, conventional learning optimizers may require task-specific optimizer tuning. The system can improve generalization by training the optimizer neural network with a combination of loss functions. The optimizer neural network can be trained using a combination of loss functions, where one of the loss functions is an imitation loss that acts as a regularizer that prevents the optimizer neural network from over-fitting on the task it is trained on. Thus, after being trained, the optimizer neural network can be generalized to a wide variety of tasks and network architectures.

For example, the optimizer neural network can be trained on architectures such as multilayer perceptrons (MLPs), and then used to train a more complicated trainee neural network than an MLP, such as a vision transformer (ViT). This generalization can save significant computing time and resources during the training of the optimizer neural network because the optimizer neural network does not have to be trained specifically for every type of network architecture or task.

The system can achieve faster convergence and reduce training time of the trainee neural network. For example, the system can converge faster than conventional optimizers while retaining similar asymptotic performance, for example, by training the optimizer neural network with a combination of loss functions.

As another example, in robotics applications, the system can be applied to learning trajectory optimization to be used in robot navigation. The system can accelerate the optimization algorithm by using an optimizer neural network to learn an initialization for the trajectory optimization. For example, the optimizer neural network can determine an initial starting point for the optimization algorithm. The trajectory optimization can be sufficiently accelerated using the optimizer neural network so that the optimization algorithm can be used in real-time for robot navigation.

In addition, the system can reduce instability. The system can reduce instability by training the optimizer neural network with imitation loss, i.e., an imitation loss that measures a mean squared error between the updates of the optimizer neural network and a momentum-based machine learning optimizer.

An optimizer neural network as described in this specification can train a trainee neural network that is a transformer efficiently because the optimizer neural network improves convergence, reduces training time, and do not have to be trained on the task of training a transformer (e.g., the optimizer neural network can be trained on the task of training a MLP but used at inference to train a transformer). Typically, it can be difficult to train a trainee neural network that is a transformer because transformer training often requires nontrivial optimization techniques, e.g., learning rate schedulers. In addition, for larger architectures, training can be prohibitively slow. Thus, the system can use an optimizer neural network as described in this specification to efficiently train a trainee neural network that is a transformer.

The system can be more efficient than conventional systems. For example, the optimizer neural network requires minimal input feature engineering, saving computational time and resources.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example neural network training system.

FIGS. 2A-2B are flow diagrams of an example process for training a trainee neural network.

FIG. 3 is a diagram of an example hidden state.

FIG. 4 shows another neural network training system.

FIG. 5 is a diagram of another example process for training a trainee neural network.

FIG. 6 is a flow diagram of another example process for training a trainee neural network.

FIG. 7 is a flow diagram of an example process for generating a network output conditioned on a network input.

Like reference numbers and designations in the various drawings indicate like elements.

### DETAILED DESCRIPTION

This specification describes a system implemented as computer programs on one or more computers in one or more locations that uses a neural network to perform a task.

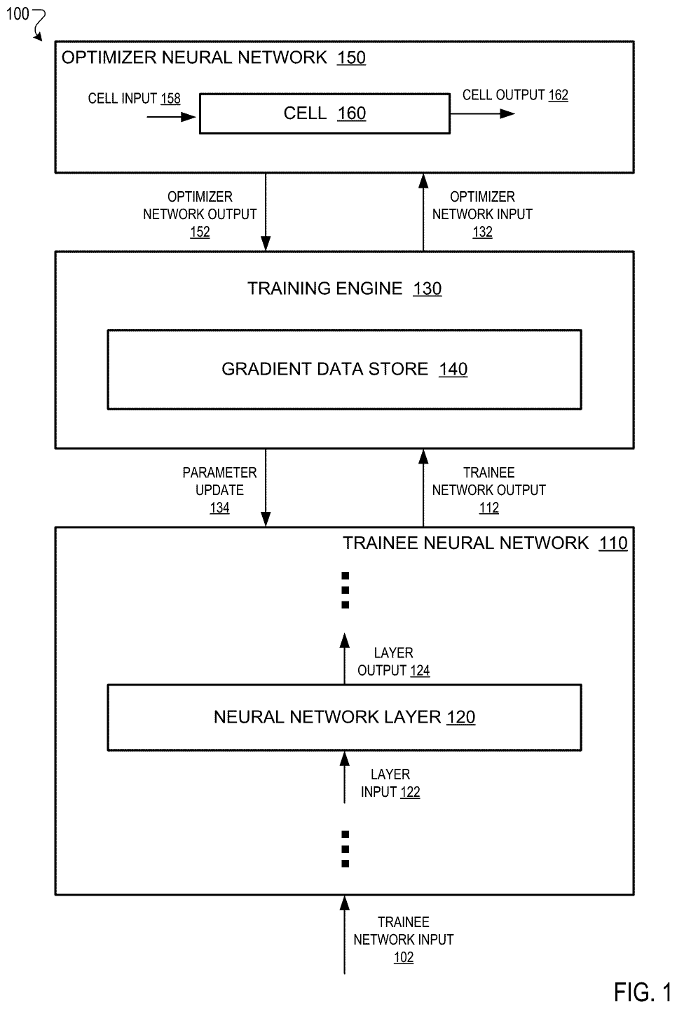

For example, the task for the neural network can be to serve as an optimizer neural network. The optimizer neural network can be configured to train a trainee neural network that is configured to perform a particular machine learning task. Example machine learning tasks are described with reference to FIG. 1.

The system can be configured to train trainee neural networks of any of a variety of architectures. For example, the trainee neural network can be a classifier, an MLP, a recurrent neural network (RNN), a convolutional neural network (CNN), or a transformer, such as a ViT, etc. The system can also be configured to pre-train or prompt-tune models such as ViTs or bidirectional encoder representations from transformers (BERT) models.

Another example task for the optimizer neural network can be to guide the training process of a neural network. For example, the optimizer neural network can determine an initialization for the training of a trainee neural network.

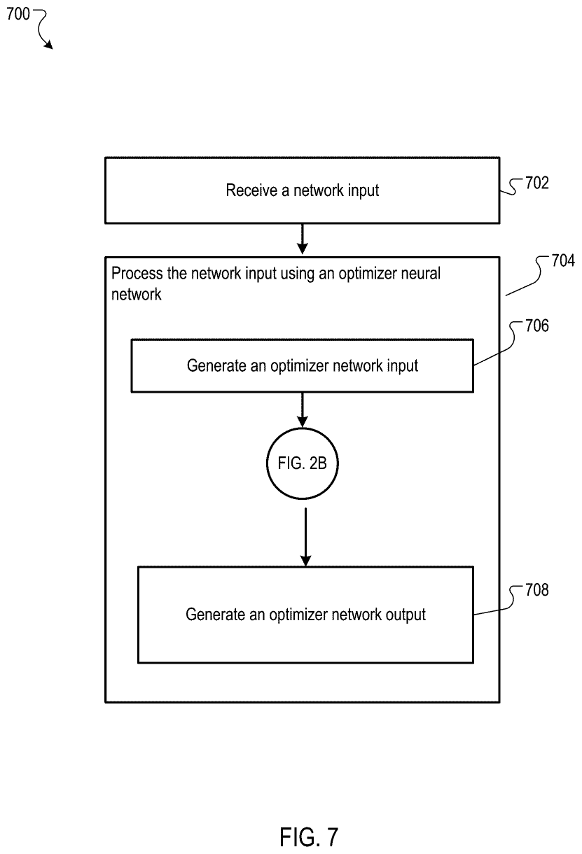

As another example, the optimizer neural network can guide an optimization process, for example, an optimization algorithm for trajectories used in Model Predictive Control (MPC) for robot navigation, as described below with reference to FIG. 7. For example, the optimizer neural network can determine a starting point for an optimization algorithm, making trajectory optimization more efficient and real-time.

FIG. 1 shows an example neural network training system. The training system 100 is an example of a system implemented as computer programs on one or more computers in one or more locations, in which the systems, components, and techniques described below can be implemented.

The training system includes a trainee neural network 110, a training engine 130, and an optimizer neural network 150. The training system 100 is configured to train a trainee neural network 110 to perform a machine learning task. The trainee neural network 110 can be configured to process a trainee network input 102 and to generate a trainee network output 112 that represents a prediction about the trainee network input 102 for the machine learning task. Example machine learning tasks for which training system 100 can train the trainee neural network 110 are discussed below.

In particular, the training system 100 can use the optimizer neural network 150 to train a particular neural network layer 120 of the trainee neural network 110. The neural network layer 120 can be configured to process a layer input 122 using at least a parameter tensor to generate a layer output 124. The parameter tensor can include multiple network parameters, and can have multiple dimensions each with multiple indices.

For example, the parameter tensor can be an N×M matrix, i.e., can include two dimensions where a first dimension has M indices and a second dimension has N indices. As another example, the parameter tensor can be an N×M×C matrix, i.e., can include three dimensions where a first dimension has M indices, a second dimension has N indices, and a third dimension has C indices.

For each network parameter of the parameter tensor and at each of multiple training stages as described in more detail below, the optimizer neural network 150 can process an optimizer network input 132 corresponding to the network parameter and generate an optimizer network output 152 that represents an update to the value of the network parameter. The optimizer neural network 150 is configured to generate optimizer network outputs 152 that represent parameter updates 134 for respective individual network parameters of the parameter tensor.

In some implementations, the neural network layer 120 can include multiple different parameter tensors, where at least one of the parameter tensors are trained using the optimizer neural network 150 as described below. For example, the neural network layer 120 can be a self-attention neural network layer that is configured to apply a self-attention mechanism to the layer input 122 to generate the layer output 124, where the self-attention mechanism is parameterized by a query parameter tensor, a key parameter tensor, and a value parameter tensor.

The trainee neural network 110 can include multiple neural network layers. In some implementations, the training system 100 trains multiple different neural network layers of the trainee neural network 110 using the optimizer neural network 150 as described below. For example, each neural network layer of the trainee neural network 110 can be trained using the same optimizer neural network 150.

At each of multiple training stages during the training of the trainee neural network 110, the training engine 130 is configured to process one or more trainee network inputs 102, from a training data set of trainee network inputs 102, using the trainee neural network 110 to generate respective trainee network outputs 112. That is, at each training stage, the trainee neural network 110 can process a respective different batch or mini-batch of training examples from the training data set.

At each training stage and for each network parameter of the parameter tensor of the neural network layer 120, the training engine 130 can use the generated trainee network outputs 112 to generate an optimizer network input 132 for the optimizer neural network 150, provide the optimizer network input 132 to the optimizer neural network 150 for generating an optimizer network output 152, determine a parameter update 134 for the network parameter using the optimizer network output 152, and update the network parameter by applying the parameter update 134.

In particular, the training engine 130 can process the trainee network outputs 112 generated during the current training stage according to a loss function for the machine learning task in order to determine an error of the traince network outputs 112. The training engine 130 can use the determined error to generate, for each network parameter of the parameter tensor of the neural network layer 120, a gradient of the loss function with respect to the network parameter. For example, the training engine 130 can backpropagate the error through the traince neural network 110 to the neural network layer 120 to generate the gradients for the network parameters of the parameter tensor of the neural network layer 120.

The training engine 130 can use any appropriate technique to determine the error of the trainee network outputs 112. For example, if the training data set includes a label for each trainee network input 102 in the training data set that identifies a ground-truth trainee network output that should be generated by the trainee neural network 110 in response to processing the trainee network input 102, then the training engine 130 can use a supervised loss function to determine the error, e.g., by determining the mean squared error or cross entropy loss between the traince network outputs 112 and the corresponding ground-truth trainee network outputs. As another example, if the training data set does not include labels for the traince network inputs 102 in the training data set, the training engine 130 can determine the error of the trainee network outputs 112 using any appropriate unsupervised or self-supervised training technique.

The training engine 130 can include a gradient data store 140 that is configured to maintain, for each network parameter of the parameter tensor of the neural network layer 120, data representing historical gradients of the network parameter. For example, the gradient data store 140 can maintain data representing a low-rank approximation for the sequence of gradients generated for the network parameter at respective training stages.

In some examples, for each index of each dimension of the parameter tensor of the neural network layer 120, the gradient data store 140 can maintain a respective value corresponding to the index of the dimension. In some examples, the value can represent a moving average of the historical gradients of the parameters of the parameter tensor that have the particular index in the particular dimension. For example, the value can be a moving average of the sum of the historical gradients of the parameters that have the particular index in the particular dimension. As another example, the value can be a moving average of the squared sum of the historical gradients of the parameters that have the particular index in the particular dimension. As another example, the value can be a moving average, across training stages, of the maximum gradient of the parameters that have the particular index in the particular dimension at each training stage. As another example, the value can be a moving average, across training stages, of the maximum squared gradient of the parameters that have the particular index in the particular dimension at each training stage. As a particular example, if the parameter tensor has dimension M×N, then the gradient data store 140 can maintain M values corresponding to respective rows of the parameter tensor and N values corresponding to respective columns of the parameter tensor.

At each training stage, the training engine 130 can update the gradient data store 140 using the new gradients generated from the trainee network outputs 112 generated at the training stage. That is, for each network parameter, the training engine 130 can use the new gradient for the network parameter to update the data, maintained by the gradient data store 140, representing the historical gradients for the network parameter.

After updating the data maintained by the gradient data store 140, the training engine 130 can generate, for each network parameter of the parameter tensor, a respective optimizer network input 132.

In some implementations, for each network parameter of the parameter tensor, the optimizer network input 132 for the network parameter includes the respective obtained values. For example, the optimizer network input 132 can be a vector where at least some of the elements of the vector are values obtained from the gradient data store 140 corresponding to respective dimensions.

In some other implementations, for each network parameter of the parameter tensor, the training engine 130 generates the optimizer network input 132 for the network parameter by updating the respective obtained values. For example, the training engine 130 can process the obtained values to normalize and/or to otherwise modify them, and include the processed values in the optimizer network input 132. As a particular example, the training engine 130 can normalize the values so that the values across the parameter tensor have a second moment of 1.

In some implementations, for each network parameter of the parameter tensor of the neural network layer 120, the optimizer network input 132 for the network parameter includes (or is generated from) one or more other terms in addition to the values maintained by the gradient data store 140 described above. The additional terms can also be stored by the gradient data store 140 during the training of the trainee neural network 110.

For example, each optimizer network input 132 can include or be generated from one or more of the following:
the new gradient of the loss function for the network parameter;
a magnitude of the new gradient of the loss function for the network parameter;
a direction of the new gradient of the loss function for the network parameter;
a value of the loss function for the network parameter;
a validation loss, where the validation loss is the loss function measured on validation examples;
gradient clipping values derived from the new gradients of the loss function for the network parameter;
the current value of the network parameter;
one or more momentum terms for the gradients of the network parameter, where each momentum term corresponds to a respective different (optionally machine-learned, e.g., learned concurrently with the training of the optimizer neural network 150) time scale;
a second moment term for the gradients of the network parameter;
one or more normalized momentum terms (corresponding to respective, optionally machine-learned, time scales) that have been normalized using the second moment term for the gradients of the network parameter, e.g., −m/\sqrt{v} where m is the raw momentum term and v is the second moment term;
an inverse of a root of a noisy second moment term (e.g., a value generated by adding noise to the second moment value) for the gradients of the network parameter, e.g., (\sqrt{vϵ})⁻¹, where ϵ is either (i) a predetermined value such as 1e-5 or 1e-9 or (ii) a randomly-sampled noise term, e.g., randomly-sampled from a Normal distribution.

After generating the respective optimizer network input 132 for each network parameter of the parameter tensor of the neural network layer 120, the training engine 130 can provide the optimizer network inputs 132 to the optimizer neural network 150. For each network parameter, the optimizer neural network 150 can then process the optimizer network input 132 to generate an optimizer network output 152 defining a parameter update 134 for the network parameter.

In some implementations, the optimizer neural network 150 processes at least some of the optimizer network inputs 132 corresponding to respective network parameters in parallel. For example, the optimizer neural network 150 can process the optimizer network input 132 for each network parameter in the parameter tensor in parallel.

The optimizer neural network 150 can have any appropriate network architecture. For example, the optimizer neural network 150 can include a sequence of cells such as the cell 160. Each cell can be a memory cell. Each cell can include, for example, 16 hidden dimensions and one attention head, and use an exponential discount factor τ=0.1, and r=16 random projections.

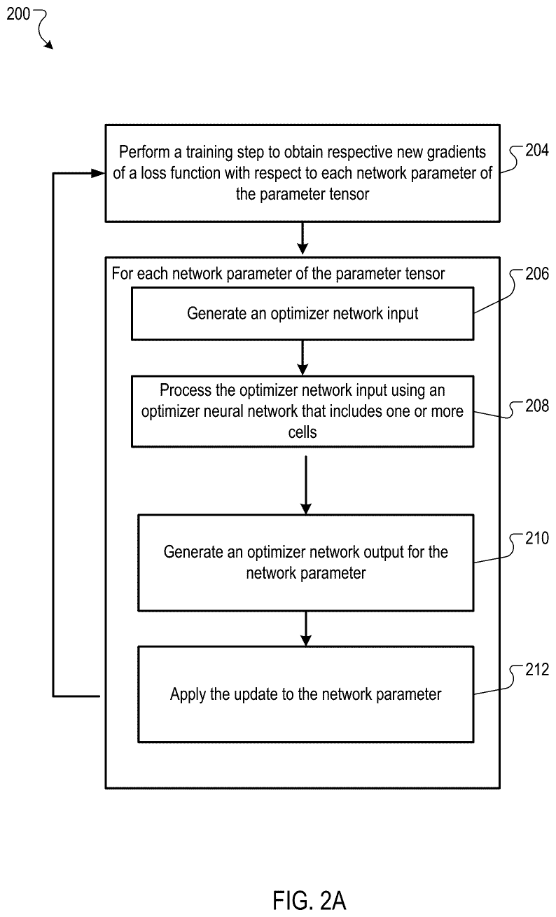

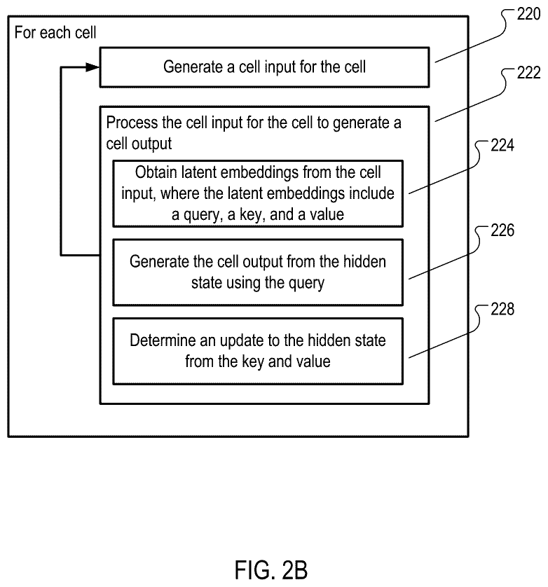

Each cell 160 maintains one or more hidden states. For each cell 160, the optimizer neural network 150 can generate a cell input 158 for the cell from at least the optimizer network input 132. The optimizer neural network 150 can process the cell input 158 to generate a cell output 162. The cell output 162 defines an update to at least one hidden state of the cell 160. For example, the cell 160 can obtain latent embeddings from the cell input that include a query, a key, and a value. The cell 160 can generate the cell output from the hidden state using the query of the latent embeddings. The cell 160 can then determine an update to the hidden state from the key and value. Processing the cell input 158 to generate the cell output 162 is described in further detail below with reference to FIG. 2B.

The cell 160 can part of a sequence of two or more cells. The cell input for each cell after a first cell of the sequence can be generated from the cell output of a previous cell in the sequence.

The optimizer neural network 150 can also include neural network layers that receive a cell output from a last cell in the sequence and generate the optimizer network output 152. That is, the optimizer neural network 150 can provide the cell output from the last cell to the one or more neural network layers. The one or more neural network layers can include, for example, an MLP.

In some implementations, the optimizer neural network 150 can be implemented on parallel processing devices, e.g., special-purpose hardware such as tensor processing units (TPUs), for efficient execution at training and/or inference time. As a particular example, the optimizer neural network 150 can be implemented on special-purpose hardware that includes specialized matrix multiplication units that operate on fixed-dimensional matrices (e.g., the TPUv2 hardware includes 128×128 systolic arrays). In some implementations, utilizing these specialized matrix multiplication units can significantly improve the efficiency of the implementation of the optimizer neural network on the parallel processing device. In some other implementations, for at least some of the matrix multiplications in the implementation of the optimizer neural network, the size of the matrices in the matrix multiplication is significantly smaller than the fixed-dimensional matrices for which the specialized matrix multiplication units of the parallel processing device have been configured, which can cause inefficiencies because of underutilization of the specialized matrix multiplication units. Thus, these matrix multiplications can instead be implemented in the parallel processing device as a set of vector multiplications or element-wise operations, significantly improving the efficiency of the optimizer neural network relative to a naïve implementation that implements the matrix multiplications using the specialized matrix multiplication units (e.g., the time required to execute the optimizer neural network can be halved).

For each network parameter of the parameter tensor of the neural network layer 120, the corresponding optimizer network output 152 can define a parameter update 134 for the network parameter in any appropriate way. For example, the optimizer network output 152 can be a single value representing the parameter update 134; that is, the parameter update 134 can be applied by adding the single value of the optimizer network output 152 to the current value for the network parameter.

After receiving the optimizer network output 152 for each network parameter, the training engine 130 can generate the parameter update 134 for the network parameter from the optimizer network output 152 and apply the parameter update 134 to update the current value of the network parameter.

The training system 100 can determine to end training of the trainee neural network 110 in any appropriate way. For example, the training system 100 can determine to end training after a predetermined number of training stages. As another example, the training system 100 can determine to end training when a predetermined performance (e.g., a training or validation accuracy) of the trainee neural network 110 is achieved. As another example, the training system 100 can determine to end training when a marginal improvement in the performance (e.g., in the training or validation accuracy) of the trainee neural network 110 between respective training stages drops below a predetermined threshold.

After the traince neural network 110 is trained (i.e., after the final training stage of the training system 100), the trainee neural network 110 can be deployed in any appropriate inference environment. For example, the traince neural network 110 can be deployed in a cloud computing environment such as a data center, or on a user device such as a mobile phone, tablet, or laptop. Typically, the optimizer neural network 150 is not deployed with the traince neural network 110; that is, after training, the traince neural network 110 can operate without the optimizer neural network 150. After deployment, the trainee neural network 110 can receive new trainee network inputs 102 and process the new trainee network inputs 102 according to the trained values for the network parameters of the trainee neural network 110 to generate new trainee network outputs 112 for the new traince network inputs 102.

The optimizer neural network 150 can be trained in any appropriate way. Generally, a training system can train the optimizer neural network 150 using a set of one or more trainee neural networks (which may or may not include the trainee neural network 110) configured to performs respective machine learning tasks, e.g., the same machine learning task or respective different machine learning tasks. The training system can use the optimizer neural network 150 to execute a number of training stages of the traince neural networks, and update the network parameters of the optimizer neural network 150 based on an average error (e.g., as measured by training or validation loss) of the traince neural networks across the training stages.

As a particular example, the training system can train the optimizer neural network 150 to minimize a combination of loss functions. For example, the first loss function can be the loss for the machine learning task of the traince neural network 110. The second loss function can be an imitation loss that measures a mean squared error between updates generated by the optimizer neural network 150 and corresponding updates generated by a momentum-based machine learning optimizer. For example, the momentum-based machine learning optimizer can be an Adam optimizer or AdamW optimizer.

In some examples, the training system can train the optimizer neural network for one or more trainee neural networks. The optimizer neural network can be used at inference for a trainee neural network that the optimizer neural network was not trained on. For example, the optimizer neural network can be trained on architectures such as an MLP, and then used to train a ViT.

In some implementations, the respective machine learning tasks of the trainee neural networks on which the optimizer neural network 150 is trained are different from the particular machine learning task for which the trainee neural network 110 is configured. That is, the optimizer neural network 150 can be used to train trainee neural networks 110 for machine learning tasks for which the optimizer neural network 150 was not trained to generate parameter updates.

The traince neural network 110 can be trained to perform any appropriate machine learning task, i.e., can be configured to receive any appropriate kind of digital data input 102 and to generate any appropriate kind of score, classification, or regression output based on the input 102.

In some cases, the trainee neural network 110 is a neural network that is configured to perform an image processing task, i.e., receive an input image and to process the input image to generate a network output for the input image. For example, the task may be image classification and the output generated by the trainee neural network for a given image may be scores for each of a set of object categories, with each score representing an estimated likelihood that the image contains an image of an object belonging to the category. As another example, the task can be image embedding generation and the output generated by the trainee neural network can be a numeric embedding of the input image. As yet another example, the task can be object detection and the output generated by the trainee neural network can identify locations in the input image at which particular types of objects are depicted. As yet another example, the task can be image segmentation and the output generated by the traince neural network can assign each pixel of the input image to a category from a set of categories.

As another example, if the inputs 102 to the traince neural network 110 are Internet resources (e.g., web pages), documents, or portions of documents or features extracted from Internet resources, documents, or portions of documents, the task can be to classify the resource or document, i.e., the output generated by the trainee neural network 110 for a given Internet resource, document, or portion of a document may be a score for each of a set of topics, with each score representing an estimated likelihood that the Internet resource, document, or document portion is about the topic.

As another example, if the inputs 102 to the traince neural network 110 are features of an impression context for a particular advertisement, the output generated by the trainee neural network 110 may be a score that represents an estimated likelihood that the particular advertisement will be clicked on.

As another example, if the inputs 102 to the trainee neural network 110 are features of a personalized recommendation for a user, e.g., features characterizing the context for the recommendation, e.g., features characterizing previous actions taken by the user, the output generated by the trainee neural network 110 may be a score for each of a set of content items, with each score representing an estimated likelihood that the user will respond favorably to being recommended the content item.

As another example, if the input 102 to the trainee neural network 110 is a sequence of text in one language, the output generated by the trainee neural network may be a score for each of a set of pieces of text in another language, with each score representing an estimated likelihood that the piece of text in the other language is a proper translation of the input text into the other language.

As another example, the task may be an audio processing task. For example, if the input to the trainee neural network 110 is a sequence representing a spoken utterance, the output generated by the trainee neural network 110 may be a score for each of a set of pieces of text, each score representing an estimated likelihood that the piece of text is the correct transcript for the utterance. As another example, the task may be a keyword spotting task where, if the input to the trainee neural network 110 is a sequence representing a spoken utterance, the output generated by the trainee neural network 110 can indicate whether a particular word or phrase (“hotword”) was spoken in the utterance. As another example, if the input to the trainee neural network 110 is a sequence representing a spoken utterance, the output generated by the trainee neural network 110 can identify the natural language in which the utterance was spoken.

As another example, the task can be a natural language processing or understanding task, e.g., an entailment task, a paraphrase task, a textual similarity task, a sentiment task, a sentence completion task, a grammaticality task, and so on, that operates on a sequence of text in some natural language.

As another example, the task can be a text to speech task, where the input 102 is text in a natural language or features of text in a natural language and the network output is a spectrogram or other data defining audio of the text being spoken in the natural language.

As another example, the task can be a health prediction task, where the input 102 is electronic health record data for a patient and the output is a prediction that is relevant to the future health of the patient, e.g., a predicted treatment that should be prescribed to the patient, the likelihood that an adverse health event will occur to the patient, or a predicted diagnosis for the patient.

As another example, the task can be an agent control task, where the input 102 is an observation characterizing the state of an environment and the output defines an action to be performed by the agent in response to the observation. The agent can be, e.g., a real-world or simulated robot, a control system for an industrial facility, or a control system that controls a different kind of agent.

FIGS. 2A-2B are flow diagrams of an example process 200 for training a trainee neural network. For convenience, the process 200 will be described as being performed by a system of one or more computers located in one or more locations. For example, a training system, e.g., the training system 100 described above with reference to FIG. 1, appropriately programmed in accordance with this specification, can perform the process 200.

The system can train the trainee neural network to perform a machine learning task by processing a network input to generate a network output. The trainee neural network can include a neural network layer that is configured to process a layer input in accordance with at least a parameter tensor to generate a layer output. The parameter tensor can include multiple network parameters and can have a multiple dimensions each having a respective set of multiple indices.

Referring to FIG. 2A, the system can perform steps 204-212 at each of multiple training stages for the trainee neural network.

The system performs, using one or more training examples, a training step to obtain respective new gradients of a loss function for the machine learning task with respect to each of the multiple network parameters of the parameter tensor (step 204).

The system can perform steps 206-212 for each of the network parameters of the parameter tensor of the neural network layer. For example, the system can perform the steps 206-212 for each network parameter xi in parallel.

The system generates an optimizer network input for the network parameter from at least the new gradient with respect to the network parameter (step 206). The optimizer network input can include a tensor such as a two-dimensional vector of the absolute value of the gradient dimension and its sign. For example, the optimizer network input can include any one or more of the new gradient of the loss function for the network parameter, the respective magnitude and respective direction of the new gradient of the loss function for the network parameter, momentum values derived from the new gradients of the loss function for the network parameter, gradient clipping values derived from the new gradients of the loss function for the network parameter, and a value of the loss function for the network parameter. The optimizer network input can also include a validation loss, where the validation loss is the loss function measured on a plurality of validation examples.

The system can also generate the optimizer network from one or more of: a transformed mean momentum term, a sign of a mean momentum term, a transformed variance squared of momentum term, a transformed mean of a second moment term, a sign of a mean of a second moment term, a transformed mean value of the network parameters of the neural network layer, a sign of a mean value of the network parameters of the neural network layer, a transformed variance squared of the values of the network parameters of the neural network layer, a transformed mean gradient value, a sign of a mean gradient value, a transformed variance squared gradient term, or a transformed mean absolute value gradient term.

The system processes the optimizer network input using an optimizer neural network (step 208). For example, the optimizer neural network can be the optimizer neural network 150 described above with reference to FIG. 1. The optimizer neural network includes a sequence of one or more cells such as the cell 160 described above with reference to FIG. 1.

Referring to FIG. 2B, the system can perform steps 220-228 for each cell. Each cell can maintain one or more hidden states.

The system generates a cell input for the cell (step 220). For example, the system can generate the cell input ξ^{μ} for the cell from at least the optimizer network input. For example, the cell input can include the optimizer network input or be a patch of the optimizer network input. The cell input ξ^{μ} is also referred to as a pattern or memory-vector, where {ξ^{μ}}_{μ=1}^{M}⊆ [symbol] ^{d} and μ serves as a timestamp for the training stage.

In implementations where the optimizer neural network includes a sequence of more than one cell, for each cell after the first cell, the system can generate the cell input from the cell output of a previous cell in the sequence. For example, the cell input for the second cell in the sequence can be the cell output of the first cell in the sequence.

The system processes the cell input for the cell to generate a cell output (step 222). The cell output can define an update to at least one hidden state of the cell. The system can perform steps 224-228 as part of step 222.

For example, the system obtains latent embeddings from the cell input, where the latent embeddings include a query, a key, and a value (step 224). For example, the system can obtain the query, key, and value using learnable linear transformations W_{Q}, W_{K}∈R^{N×d}, W_{V}∈R^{d×d} as follows:

$${q}^{μ} = \text{?} , {k}^{μ} = \text{?} , {v}^{μ} = \text{?}$$

$$\text{?} \text{indicates text missing or illegible when filed}$$

The system generates the cell output from the hidden state using the query (step 226).

For example, the cell output ξ′ is described by ξ′=ξ+Δξ, where

$$Δξ = \frac{\text{?} ϕ ( q )}{ϕ ( q \text{?}} .$$

$$\text{?} \text{indicates text missing or illegible when filed}$$

That is, the system can generate the cell output by adding, to the cell input, the key-value hidden state element multiplied by a feature mapping of the query divided by a transposed feature mapping of the query multiplied by the key hidden state element.

The system determines an update to the hidden state from the key and value (step 228). For example, each hidden state h_{Mno}(t)=(Nₜ, Ψₜ) can include two elements, a key-value hidden state element Nₜ and a key hidden state element Ψₜ. The key-value hidden state element and key hidden state element are defined, for the first t patterns that are stored, as:

$$\{ \begin{matrix}{N}_{t} = {\sum }_{μ = 1}^{t} {λ}_{t} ( μ ) ϕ ( {k}^{μ} ) {( {v}^{μ} )}^{T} ∈ {ℝ}^{r \times d} \\ {Ψ}_{t} = {\sum }_{μ = 1}^{t} {λ}_{t} ( μ ) ϕ ( {k}^{μ} ) ∈ {ℝ}^{r}\end{matrix} ,$$

where ϕ(x), ϕ(y) are random feature vectors, also referred to as the feature mapping. λₜ is a discount factor. The discount factor can be exponential, for example, λₜ(μ)=exp(−τ(t−μ)) with τ≥0. The discount factor can be applied to deprioritize older patterns.

The update to the hidden state can be represented as

$${N}_{t + 1} = exp ( - τ ) \cdot {N}_{t} + ϕ ( {k}^{t + 1} ) {( {v}^{t + 1} )}^{T} ,$$

$${Ψ}_{t + 1} = exp ( - τ ) \cdot {Ψ}_{t} + ϕ ( {k}^{t + 1} )$$

That is, to determine the update to the hidden state, the system can generate an update to the key-value hidden state element from at least a sum of a product between a feature mapping of the key and a transposed value. The system can also generate an update to the key hidden state element from at least a feature mapping of the key.

The system can determine the update to the hidden state by updating the key-value hidden state element by computing a sum of the key-value hidden state element multiplied by a discount factor with the update to the key-value hidden state element, and updating the key hidden state element by computing a sum of the key hidden state element multiplied by the discount factor with the update to the key-value hidden state element.

The feature mapping maps a key and a query from a first dimension to a second dimension. The feature mapping can approximate a kernel that is a similarity measure between a key and a query. For example, the kernel can be represented by K: [symbol] ^{N}× [symbol] ^{N}→ [symbol] and its linearization can be represented by K(x,y)= [symbol] [ϕ(x)^{T}ϕ(y)]. In some implementations, the kernel is a softmax kernel. The system can thus approximate kernel values for an approximated attention mechanism.

In some implementations, the feature mapping is a positive random feature mapping obtained using orthogonal random features. For example, the feature mapping can be represented as

$${ϕ}_{F +} ( z ) = Γ ( z , r ) {( exp ( {ω}_{1}^{T} z ) , … , exp ( {ω}_{r}^{T} z ) )}^{T}$$

where

$$Γ ( z , r ) {=}^{def} \frac{1}{\sqrt{r}} exp ( - \frac{{‖ z ‖}^{2}}{2} )$$

and ω₁, . . . , ωᵣ˜N(0,I_{N}). The random vectors ω₁, . . . , ωᵣ form a block-orthogonal ensemble.

In some implementations, the feature mapping is a positive random feature mapping obtained using hyperbolic cosine random features. For example, the feature mapping can be represented as

$${ϕ}_{HF +} ( z ) = Γ ( z , r ) {\prod }_{i = 1}^{\frac{r}{2}} {( exp ( {ω}_{i}^{T} z ) , exp ( - {ω}_{i}^{T} z ) )}^{T}$$

In some implementations, the feature mapping is generated from at least four variables and random vectors. At least one of the four variables can be derived from a parameter ρ. For example, the feature mapping can be represented as

$${ϕ}_{F ++} ( z ) = \frac{D}{\sqrt{r}} {\prod }_{i = 1}^{r} {exp ( - \hat{A} {‖ {ω}_{i} ‖}_{2}^{2} + B {ω}_{i}^{T} z + C {‖ z ‖}^{2} )}^{T}$$

$$where \hat{A} = - A , \text{} B = \sqrt{1 + 4 \hat{A}} , \text{} C = - \frac{1}{2} , \text{} D = {( 1 + 4 \hat{A} )}^{\frac{N}{4}} , \text{} A = 1 - \frac{1}{ρ} and ρ ∈ ( 0 , 1 )$$

is the parameter. That is, a first variable A can be derived from an inverse of the parameter, a second variable B and a third variable D can be derived from the first variable, and a fourth variable C can be a scalar value.

The parameter can be derived from the query and the key. For example, an optimal choice for the parameter can be represented by

$${ρ}^{*} = \frac{\sqrt{{( 2 γ + N )}^{2} + 8 N γ} - 2 γ - N}{4 γ}$$

where

$$γ = \frac{1}{{M}^{2}} {\sum }_{i = 1}^{M} {\sum }_{j = 1}^{M} {‖ {q}^{i} + {k}^{j} ‖}^{2}$$

and N is a length of the latent embeddings. That is, the parameter can be derived by computing a square root of a sum of (i) a multiple of a normalized squared sum of a norm of the query and the key and (ii) a length of the latent embeddings, subtracted by a multiple of a normalized squared sum of a norm of the query and the key, subtracted by a length of the latent embeddings, and divided by a multiple of a normalized squared sum of a norm of the query and the key.

Example feature mappings are described in more detail in “Chefs' Random Tables: Non-Trigonometric Random Features,” Likhosherstov et al., arXiv:2205.15317 and “Rethinking Attention with Performers,” Choromanski et al., arXiv:2009.14794.

In some implementations, the hidden state can be a “thickened state” represented as

$${H}_{Mne} ( t ) = ( {\{ {N}_{t}^{ρ} \}}_{ρ ∈ Ω} , {\{ {Ψ}_{t}^{ρ} \}}_{ρ ∈ Ω} , {\sum }_{t} , {Λ}_{t} )$$

where

$${\sum }_{t} = {\sum }_{j = 1}^{t} {k}^{j} , {Λ}_{t} = {\sum }_{j = 1}^{t} {‖ {k}^{j} ‖}_{2}^{2}$$

and Nₜ^{ρ}, Ψₜ^{ρ} correspond to versions of Nₜ and Ψₜ, using parameter p to define the feature mapping ϕ. The set Ω can be obtained by discretizing the interval (0,1) into a fixed number of chunks c and quantizes ρ∈(0,1). That is, the one or more cells can each maintain a respective key-value hidden state element and key hidden state element for each of a plurality of slices of the hidden state corresponding to possible values of the parameter, a summed key element, and a summed norm of the key hidden state element.

In these implementations, the system can determine an update to the hidden state by updating the thickened state, computing ρ*, and finding ρ∈Ω closest to ρ* to transform an input, and using for that the slice of the hidden state corresponding to ρ.

That is, the system can update the key-value hidden state element, key hidden state element, summed key element, and summed norm of the key hidden state element using the latent embeddings. The system can determine a value for the parameter using the updated hidden state elements. The system can select the slice of the hidden state corresponding to the determined value for the parameter. The system can use the key-value hidden state element and key hidden state element corresponding to the slice to generate the cell output.

Returning to FIG. 2A, the system generates an optimizer network output defining an update for the network parameter (step 210). The optimizer neural network can include one or more neural network layers such as an MLP layer that receive a cell output ξ′ from a last cell in the sequence and generate the optimizer network output Δxᵢ. The optimizer neural network can generate the optimizer neural network output by providing the cell output for the last cell in the sequence to the one or more neural network layers.

The system applies the update to the network parameter (step 212). For example, the system can update the network parameter xᵢ with Δxᵢ.

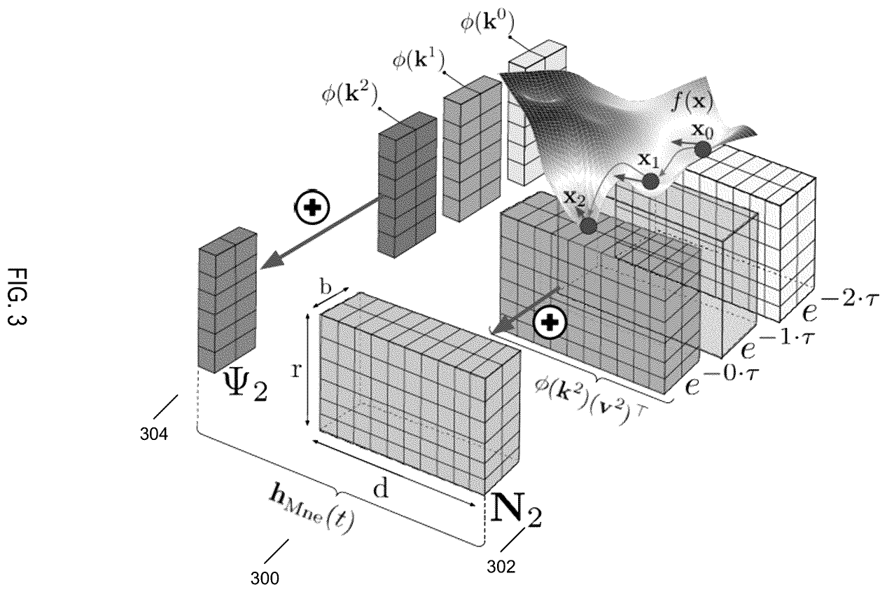

FIG. 3 is a diagram of an example hidden state 300 of a cell. The hidden state 300 encapsulates memory of first t patterns. In the example of FIG. 3, t=2. The hidden state 300 includes a key-value hidden state element 302, N₂ and a key hidden state element 304, Ψ₂.

FIG. 3 shows that N₂ is the sum of a product between a feature mapping of the key and a transposed value, multiplied by a discount factor, over previous training stages. For example, N₂ is the sum of ϕ(k²)e^{-0*τ}, ϕ(k¹)e^{-1*τ}, and ϕ(k⁰)e^{-2*τ}. More recent memories, depicted as cubes of darker colors, are prioritized through the exponential discount.

FIG. 3 also shows that Ψ₂ is the sum of a feature mapping of the key multiplied by a discount factor over previous training stages. For example, Ψ₂ is the sum of ϕ(k²)(v²)^{T}e^{-0*τ}, ϕ(k¹)(v¹)^{T}e^{-1*τ}, and ϕ(k⁰)(v⁰)^{T}e^{-2*τ}.

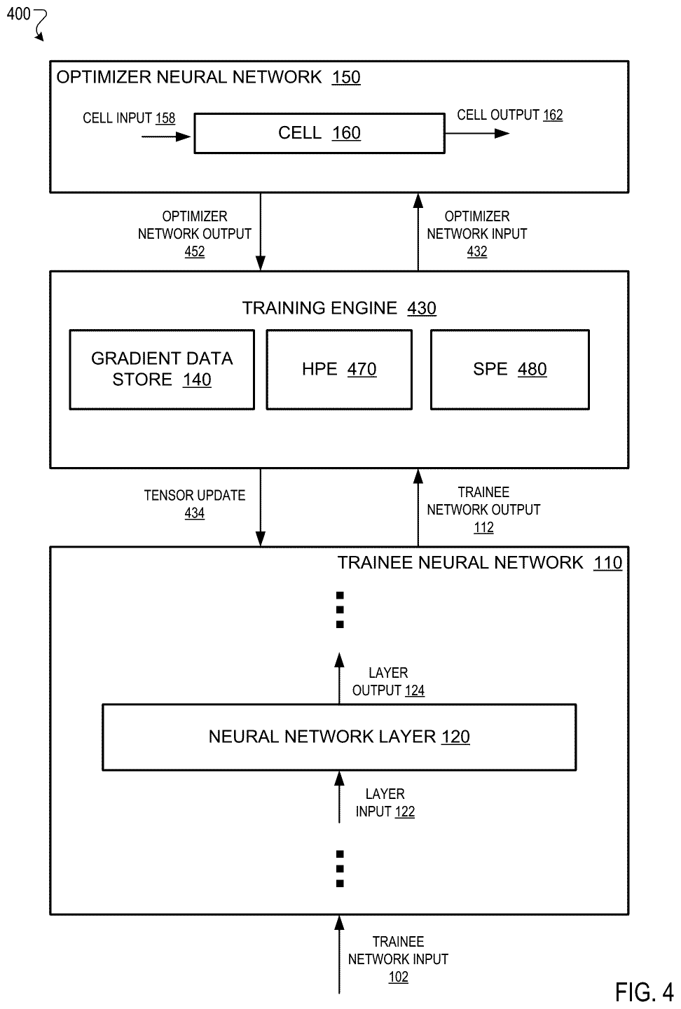

FIG. 4 shows another neural network training system. The training system 400 is an example of a system implemented as computer programs on one or more computers in one or more locations, in which the systems, components, and techniques described below can be implemented.

The training system 400 includes a trainee neural network 110 described above with reference to FIG. 1, a training engine 430, and the optimizer neural network 150 described above with reference to FIG. 1. FIG. 4 is similar to the training system 100 of FIG. 1 in that the training system is configured to train a trainee neural network 110 to perform a machine learning task.

In particular, the training system 100 can use the optimizer neural network 150 to train one or more particular neural network layers such as the neural network layer 120 of the trainee neural network 110. Each neural network layer can be configured to process a layer input such as the layer input 122 using at least a parameter tensor to generate a layer output such as the layer output 124. The parameter tensor can include multiple network parameters for one or more particular neural network layers. For example, the parameter tensor can be a square weight tensor corresponding to two consecutive neural network layers.

At each of multiple training stages as described in more detail below, the optimizer neural network 150 can process an optimizer network input 432 corresponding to a subset of the parameter tensor and generate an optimizer network output 452 that represents an update to the subset of the parameter tensor. The optimizer network output 452 can represent parameter updates for individual network parameters of the subset of the parameter tensor.

The training engine 430 is similar to the training engine 130 of FIG. 1 in that the training engine 430 can process the trainee network outputs 112 generated during the current training stage according to a loss function for the machine learning task in order to determine an error of the trainee network outputs 112. The training engine 430 can use the determined error to generate, for each network parameter of each parameter tensor, a gradient of the loss function with respect to the network parameter.

The training engine 430 can include a gradient data store 440 that is similar to the gradient data store 140. The gradient data store 440 is configured to maintain, for each network parameter of the parameter tensor, data representing historical gradients of the network parameter. At each training stage, the training engine 130 can update the gradient data store 440 using the new gradients generated from the trainee network outputs 112 generated at the training stage.

After updating the data maintained by the gradient data store 440, the training engine 430 can generate, for each subset of the parameter tensor, a respective optimizer network input 432. Each respective optimizer network input 432 can represent an encoding for the parameter tensor.

The training engine 430 can include a hierarchical pooling encoder (HPE) 470 to generate each respective optimizer network input 432. The HPE 470 can be configured to generate an encoding of an input sequence at each of multiple iterations. For example, the HPE 470 can transform the input sequence using the bi-directional attention of a Transformer-based model such as a Performer model.

As an example, the training engine 430 can flatten the parameter tensor into a sequence S_{T} of representations r, where each representation r is associated with each parameter of the parameter tensor. The HPE 470 can transform the sequence S_{T} by the bi-directional attention of a Performer model into an output sequence. The HPE 470 can perform topological encoding and use a latent encoding of a fixed token from the output sequence as the encoding.

In some examples, the HPE 470 can perform multiple iterations of topological encoding. The HPE 470 can split the sequence S_{T} into multiple subsequences of a fixed length L∈ [symbol] ₊:S_{T}¹,S_{T}², . . . . The last subsequence may be shorter. The HPE 470 can apply topological encoding to each subsequence. For example, the HPE 470 can apply topological encoding to each subsequence in parallel.

The HPE 470 can repeat the process described above by splitting each subsequence into multiple sub-subsequences and performing topological encoding on each of the sub-subsequences at each iteration. For example, the total number of iterations can be a constant hₚₒₒₗ∈ [symbol] .

For the final iteration, the final sequence has a length

$$l = \frac{\text{?}}{\text{?}}$$

$$\text{?} \text{indicates text missing or illegible when filed}$$

where len(S_{T}) is the original length. The training engine 430 can provide each of the l encodings as a respective optimizer network input 432 to the optimizer neural network 150.

The optimizer neural network 150 can then process each optimizer network input 432 to generate an optimizer network output 452 defining a tensor update 434 for the parameter tensor.

In some implementations, the optimizer neural network 150 processes at least some of the optimizer network inputs 432 in parallel.

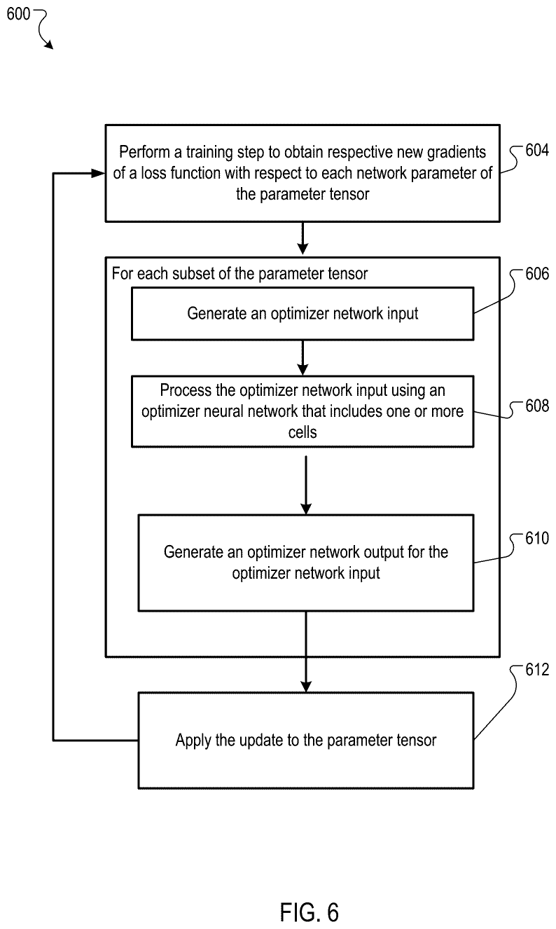

The optimizer neural network 150 is described with reference to FIG. 1. Processing the optimizer network input 432 to generate the optimizer network output 452 is described in further detail below with reference to FIG. 6.

For each subset of the parameter tensor, the corresponding optimizer network output 452 can define an update for the subset of the parameter tensor.

After receiving the optimizer network outputs for each subset of the parameter tensor, the training engine 130 can generate the tensor update 434 for the parameter tensor from the optimizer network outputs and apply the tensor update 434 to the parameter tensor. The training engine 130 can generate the tensor update 434 using a spatial attention encoder (SPE) 480.

The SPE 480 can be configured to transform multiple optimizer network outputs into a fix-sized encoding e. The encoding e is concatenated with vectors r from the sequence S_{T} to generate a vector enriched with temporal information r′=r⊙e.

The training engine 130 can generate the tensor update 434 by processing the enriched vector r′=r⊙e using one or more neural network layers. For example, the neural network layer can be a single MLP-layer.

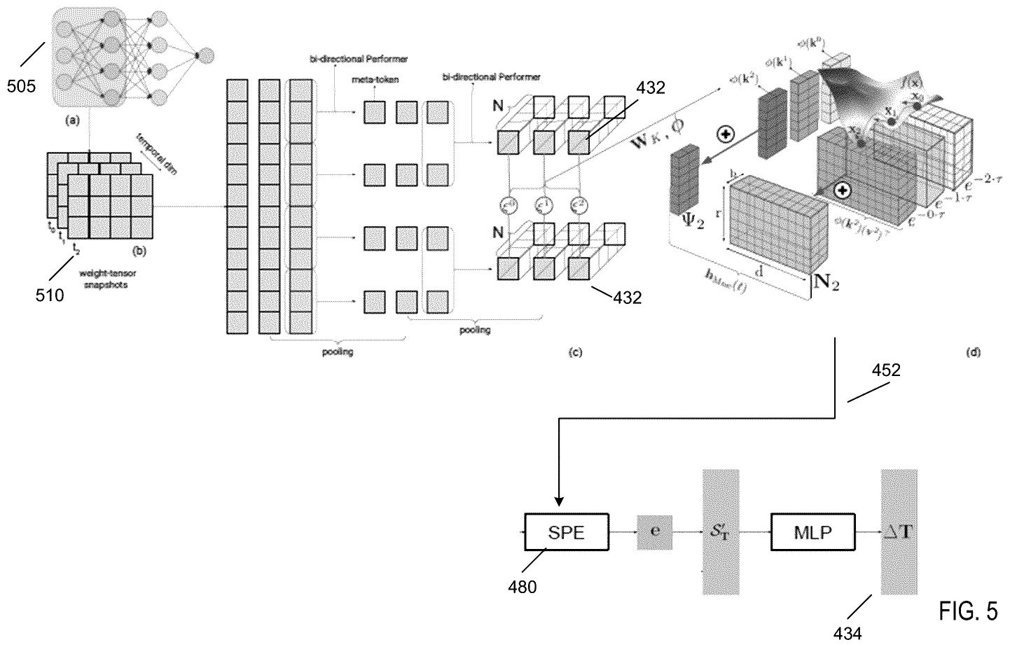

FIG. 5 is a diagram of another example process 500 for training a trainee neural network 505. For convenience, the process 500 will be described as being performed by a system of one or more computers located in one or more locations. For example, a training system, e.g., the training system 400 described above with reference to FIG. 4, appropriately programmed in accordance with this specification, can perform the process 500.

The system can perform the process 500 to train a parameter tensor 510 for a trainee neural network 505. The trainee neural network 505 can be a feedforward fully connected neural network, for example.

In the example of FIG. 5, the parameter tensor 510 is a 3×4 weight tensor. The three snapshots of the weight tensor, t₀, t₁, and t₂, represent the weight tensor at three consecutive training stages.

The system can use a hierarchical pooling encoder (HPE) 470 described above with reference to FIG. 4 to generate optimizer network inputs 432. In the example of FIG. 5, the system generates two optimizer network inputs for each training stage 0, 1, and 2.

The system can generate a cell input that includes ξ^{u} for each optimizer network input 432. The system can process the cell input to generate a cell output as described with reference to FIG. 2B, including generating the cell output from the hidden state. FIG. 5 shows the example hidden state 300 described above with reference to FIG. 3.

The system can generate the optimizer network output 452 for each optimizer network input 432 from the cell output from the last cell.

The system can provide the optimizer network outputs to the SPE 480. As described above with reference to FIG. 4, the SPE 480 can transform multiple optimizer network outputs into a fix-sized encoding e.

The system can concatenate e with vectors r from the sequence S_{T} to generate S_{T}′. The system can then generate the tensor update 434, AT using an MLP.

FIG. 6 is a flow diagram of another example process for training a trainee neural network. For convenience, the process 600 will be described as being performed by a system of one or more computers located in one or more locations. For example, a training system, e.g., the training system 400 described above with reference to FIG. 4, appropriately programmed in accordance with this specification, can perform the process 600.

The process 600 is similar to the process 200 described above with reference to FIGS. 2A-2B, but rather than generating the optimizer network input from at least the new gradient with respect to a network parameter, the optimizer network input is generated for a subset of a parameter tensor. In addition, rather than generating an optimizer network output that defines a parameter update, the optimizer network output defines a tensor update for a subset of the parameter tensor.

The system can train the trainee neural network to perform a machine learning task by processing a network input to generate a network output. The trainee neural network can include one or more neural network layers that are each configured to process a respective layer input in accordance with at least a parameter tensor to generate a respective layer output. The parameter tensor can include multiple network parameters and can have a multiple dimensions each having a respective set of multiple indices.

The system can perform steps 604-612 at each of multiple training stages for the trainee neural network.

The system performs, using one or more training examples, a training step to obtain respective new gradients of a loss function for the machine learning task with respect to each of the multiple network parameters of the parameter tensor (step 604).

The system can perform steps 606-610 for each subset of the parameter tensor. For example, the system can perform the steps 606-610 for each subset in parallel.

The system generates an optimizer network input for the subset of the parameter tensor (step 606). For example, the system can perform multiple iterations of topological encoding on a representation of the parameter tensor as described above with reference to FIG. 4. The system can generate the optimizer network input from the encoding for the last iteration corresponding to the subset.

The system processes the optimizer network input using an optimizer neural network (step 608). For example, the optimizer neural network can be the optimizer neural network 150 described above with reference to FIG. 4. The optimizer neural network includes a sequence of one or more cells such as the cell 160 described above with reference to FIG. 1.

Referring to FIG. 2B, the system can perform steps 220-228 for each cell. The cell input for the first cell can include the optimizer network input.

Returning to FIG. 6, the system generates an optimizer network output for the optimizer network input (step 610). The optimizer network output can define an update for a subset of the parameter tensor. For example, the system can generate the optimizer network output from the cell output from a last cell in the sequence.

The system applies the update to the parameter (step 612). For example, as described above with reference to FIG. 4, after generating the optimizer network outputs for all of the subsets of the parameter tensor, the system can generate a tensor update AT using an SPE and one or more neural network layers from the optimizer network outputs. The system can update the parameter tensor with AT.

In some examples, the system can perform both the process 600 and the process 200 described above with reference to FIGS. 2A-2B for the same trainee neural network. For example, the system can perform the process 200 for finetuning the top 8 layers of a ViT model, and finetune the other tensors using the process 600.

FIG. 7 is a flow diagram of an example process 700 for generating a network output conditioned on a network input. For convenience, the process 700 will be described as being performed by a system of one or more computers located in one or more locations. In the example of FIG. 7, the system can use the optimizer neural network to learn an initialization for a trajectory optimization in a model predictive control (MPC) environment.

The system can receive a network input (step 702). For example, the network input can include a context-vector. As an example, the context-vector can represent an image that encodes a scene in a model predictive control (MPC) environment. As another example, the network input can include a current robot pose, a goal pose, and a visual occupancy grid.

The system can process the network input using an optimizer neural network (step 704). The optimizer neural network can be configured to process the network input and generate an optimizer network output. The optimizer neural network can include a sequence of one or more cells that each maintain one or more hidden states.

As part of step 704, the system can perform steps 706-608 and steps 220-228 described with reference to FIG. 2B.

The system can generate an optimizer network input (step 706). For example, the system can generate the optimizer network input from at least the network input. As an example, if the network input includes a visual occupancy grid, the system can generate the optimizer network input by processing the visual occupancy grid by a convolution layer and flattening the output of the convolution layer to a sequence of tokens.

The system can perform steps 220-228 described with reference to FIG. 2B. The cell input can include patches of the network input. As an example, the cell input can include the sequence of tokens of the optimizer network input. Each token can correspond to a different patch of the visual occupancy grid, enriched with positional encoding.

The system can generate an optimizer network output (step 708). The system can generate the optimizer network output using the cell output of a last cell in the sequence of one or more cells. For example, the system can use the final embedding of one of the tokens of the sequence as a latent representation of the occupancy grid. The system can concatenate the latent representation, the current robot pose, and the goal pose. The system can process the concatenated latent representation, the current robot pose, and the goal pose using an MLP to generate the predicted action trajectory.

In the example of learning an initialization for a trajectory optimization, the optimizer neural network can have been trained with supervised learning on a dataset of sequential quadratic programming (SQP) optimization examples. For example, each example can represent an instance of trajectory optimization with SQP for each MPC step, and include an input context and the final optimal trajectory. The input context can include the current robot pose, goal pose, and visual occupancy grid, for example. The optimizer neural network can have been trained to minimize the mean squared error between the optimal trajectory and the predicted trajectory.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a key vectorboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework or a Jax framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment.

Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method of training a neural network configured to perform a machine learning task by processing a network input to generate a network output,
wherein the neural network comprises a neural network layer that is configured to process a layer input in accordance with at least a parameter tensor to generate a layer output, the parameter tensor comprising a plurality of network parameters and having a plurality of dimensions each having a respective plurality of indices,
the method comprising:
performing, at each of a plurality of iterations:
performing, using a plurality of training examples, a training step to obtain respective new gradients of a loss function for the machine learning task with respect to each of the plurality of network parameters of the parameter tensor;
for each network parameter of the plurality of network parameters of the parameter tensor:
generating an optimizer network input from at least the new gradient with respect to the network parameter;
processing the optimizer network input using an optimizer neural network, wherein the optimizer neural network comprises a sequence of one or more cells that each maintain one or more hidden states and wherein the processing comprises, for each cell:
generating a cell input for the cell from at least the optimizer network input; and
processing the cell input for the cell to generate a cell output defining an update to at least one hidden state of the cell and wherein the processing comprises:
obtaining latent embeddings from the cell input, wherein the latent embeddings comprise a query, a key, and a value;
generating the cell output from the hidden state using the query of the latent embeddings; and
determining an update to the hidden state from the key and value of the latent embeddings; and
generating an optimizer network output defining an update for the network parameter using the cell output of a last cell in the sequence of one or more cells; and
applying the update to the network parameter.

2. The method of claim 1, wherein the optimizer network input comprises (i) a respective magnitude and (ii) a respective direction of the new gradient of the loss function for the network parameter.

3. The method of claim 1, wherein the cell input for each cell after a first cell of the sequence is generated from the cell output of a previous cell in the sequence.

4. The method of claim 1, wherein the optimizer neural network further comprises one or more neural network layers that receive a cell output from a last cell in the sequence and generate the optimizer network output, and wherein generating an optimizer network output defining an update for the network parameter using the cell output of a last cell in the sequence comprises providing the cell output from the last cell to the one or more neural network layers.

5. The method of claim 1, wherein the hidden state comprises a key-value hidden state element and a key hidden state element, and wherein determining an update to the hidden state from the key and value of the latent embeddings comprises:
generating an update to the key-value hidden state element from at least a sum of a product between a feature mapping of the key and a transposed value;
generating an update to the key hidden state element from at least a feature mapping of the key; and
determining the update to the hidden state by:
updating the key-value hidden state element by computing a sum of the key-value hidden state element multiplied by a discount factor with the update to the key-value hidden state element, and
updating the key hidden state element by computing a sum of the key hidden state element multiplied by the discount factor with the update to the key-value hidden state element.

6. The method of claim 5, wherein the discount factor is exponential.

7. The method of claim 5, wherein generating the cell output from the hidden state comprises:
generating the cell output by adding, to the cell input, the key-value hidden state element multiplied by a feature mapping of the query divided by a transposed feature mapping of the query multiplied by the key hidden state element, wherein the cell output is described by:
$${ξ}^{′} = ξ + Δξ , where \text{?} .$$
$$\text{?} \text{indicates text missing or illegible when filed}$$

8. The method of claim 5, wherein the feature mapping maps a key and a query from a first dimension to a second dimension, and wherein the feature mapping approximates a kernel, wherein the kernel is a similarity measure between a key and a query.

9. The method of claim 8, wherein the kernel is a softmax kernel.

10. The method of claim 5, wherein the feature mapping is a positive random feature mapping obtained using orthogonal random features.

11. The method of claim 5, wherein the feature mapping is a positive random feature mapping obtained using hyperbolic cosine random features.

12. The method of claim 5, wherein the feature mapping is generated by:
deriving a value for a parameter from the query and the key; and
generating the feature mapping from at least four variables and random vectors, wherein at least one of the four variables is derived from the parameter.

13. The method of claim 12, wherein deriving a value for the parameter from the query comprises:
computing a square root of a sum of (i) a multiple of a normalized squared sum of a norm of the query and the key and (ii) a length of the latent embeddings, subtracted by a multiple of a normalized squared sum of a norm of the query and the key, subtracted by a length of the latent embeddings, and divided by a multiple of a normalized squared sum of a norm of the query and the key.

14. The method of claim 12, wherein a first variable of the four variables is derived from an inverse of the parameter, a second variable and a third variable of the four variables are derived from the first variable, and a fourth variable of the four variables is a scalar value.

15. The method of claim 12, wherein the one or more cells each maintain a respective key-value hidden state element and key hidden state element for each of a plurality of slices of the hidden state corresponding to possible values of the parameter, a summed key element, and a summed norm of the key hidden state element, and wherein determining an update to the hidden state from the key and value of the latent embeddings comprises:
updating the key-value hidden state element, key hidden state element, summed key element, and summed norm of the key hidden state element using the latent embeddings;
determining a value for the parameter using the updated hidden state elements;
selecting the slice of the hidden state corresponding to the determined value for the parameter; and
using the key-value hidden state element and key hidden state element corresponding to the slice to generate the cell output.

16. The method of claim 1, wherein the optimizer neural network is trained to minimize a combination of loss functions, wherein a first loss function in the combination is the loss for a training machine learning task and a second loss function is an imitation loss that measures a mean squared error between updates generated by the optimizer neural network and corresponding updates generated by a momentum-based machine learning optimizer.

17. The method of claim 16, wherein the momentum-based machine learning optimizer is one of Adam, or AdamW.

18. A method for generating a network output conditioned on a network input, the method comprising:
receiving a network input;
processing the network input using an optimizer neural network that is configured to process the network input and generate an optimizer network output, wherein the optimizer neural network comprises a sequence of one or more cells that each maintain one or more hidden states and wherein the processing comprises:
generating an optimizer network input from at least the network input;
performing, for each cell:
generating a cell input for the cell from at least the optimizer network input;
processing the cell input for the cell to generate a cell output defining an update to at least one hidden state of the cell and wherein the processing comprises:
obtaining latent embeddings from the cell input, wherein the latent embeddings comprise a query, a key, and a value;
generating the cell output from the hidden state using the query of the latent embeddings; and
determining an update to the hidden state from the key and value of the latent embeddings; and
generating an optimizer network output using the cell output of a last cell in the sequence of one or more cells.

19. A system comprising one or more computers and one or more storage devices storing instructions that are operable, when executed by the one or more computers, to cause the one or more computers to perform operations of training a neural network configured to perform a machine learning task by processing a network input to generate a network output,
wherein the neural network comprises a neural network layer that is configured to process a layer input in accordance with at least a parameter tensor to generate a layer output, the parameter tensor comprising a plurality of network parameters and having a plurality of dimensions each having a respective plurality of indices,
the operations comprising:
performing, at each of a plurality of iterations:
performing, using a plurality of training examples, a training step to obtain respective new gradients of a loss function for the machine learning task with respect to each of the plurality of network parameters of the parameter tensor;
for each network parameter of the plurality of network parameters of the parameter tensor:
generating an optimizer network input from at least the new gradient with respect to the network parameter;
processing the optimizer network input using an optimizer neural network, wherein the optimizer neural network comprises a sequence of one or more cells that each maintain one or more hidden states and wherein the processing comprises, for each cell:
generating a cell input for the cell from at least the optimizer network input; and
processing the cell input for the cell to generate a cell output defining an update to at least one hidden state of the cell and wherein the processing comprises:
obtaining latent embeddings from the cell input, wherein the latent embeddings comprise a query, a key, and a value;
generating the cell output from the hidden state using the query of the latent embeddings; and
determining an update to the hidden state from the key and value of the latent embeddings; and
generating an optimizer network output defining an update for the network parameter using the cell output of a last cell in the sequence of one or more cells; and
applying the update to the network parameter.

20. One or more non-transitory computer-readable media storing instructions that when executed by one or more computers cause the one or more computers to perform operations of training a neural network configured to perform a machine learning task by processing a network input to generate a network output,
wherein the neural network comprises a neural network layer that is configured to process a layer input in accordance with at least a parameter tensor to generate a layer output, the parameter tensor comprising a plurality of network parameters and having a plurality of dimensions each having a respective plurality of indices,
the operations comprising:
performing, at each of a plurality of iterations:
performing, using a plurality of training examples, a training step to obtain respective new gradients of a loss function for the machine learning task with respect to each of the plurality of network parameters of the parameter tensor;
for each network parameter of the plurality of network parameters of the parameter tensor:
generating an optimizer network input from at least the new gradient with respect to the network parameter;
processing the optimizer network input using an optimizer neural network, wherein the optimizer neural network comprises a sequence of one or more cells that each maintain one or more hidden states and wherein the processing comprises, for each cell:
generating a cell input for the cell from at least the optimizer network input; and
processing the cell input for the cell to generate a cell output defining an update to at least one hidden state of the cell and wherein the processing comprises:
obtaining latent embeddings from the cell input, wherein the latent embeddings comprise a query, a key, and a value;
generating the cell output from the hidden state using the query of the latent embeddings; and
determining an update to the hidden state from the key and value of the latent embeddings; and
generating an optimizer network output defining an update for the network parameter using the cell output of a last cell in the sequence of one or more cells; and
applying the update to the network parameter.
